(19) United States
(12) Patent Application Publication
(10) Pub. No.: US 2019/0377833 A1
(43) Pub. Date: Dec. 12, 2019

(54) Mobile platform for home buying tours

(71) Applicant: Paul Chay, Wesley Chapel, FL (US)

(72) Inventor: Paul Chay, Wesley Chapel, FL (US)

(21) Appl. No.: 15/932,987

(22) Filed: Jun. 6, 2018

(51) Int. Cl. G06F 17/30; H04L 29/08

(52) U.S. Cl. CPC G06F 17/30994; G06F 17/30823; H04L 67/20; G06F 17/30867; G06F 17/3087; G06F 17/30241

(57) ABSTRACT

Many single family home and condo development companies offer home buying tours as part of their sales and marketing operations. The registration process for potential buyers and their agents is managed individually by each company on various web applications. The Mobile Platform for Home Buying Tours facilitates and streamlines the process of registration for the tours. By allowing the user to register for a tour directly from relevant search results, the Mobile Platform for Home Buying Tours aggregates registrations, conveying the registration data to the development company in a consistent, timely fashion. The development company will then plan for the tour operations.

### OBJECTIVE

The invention provides a system and method of using a mobile web application platform to facilitate the registration for home buying tours directly from the search results of real properties for sale. The invention provides a unique way of quickly and repeatedly identifying the types of property and the necessary information of different real properties available in the market without DOM reload or map refresh.

### BACKGROUND

In the United States and many other countries, real properties are mostly privately owned. Many agents or developers offering home buying tours for buyers from out of state or out of country, and as such, there is a need for finding a platform of real property buying tours on the market. Some examples of websites such as http://www.topmexicorealestate.com/live-it-tour/ and http://groveresidences.com/FlyandBuv/ are commonly available in the market for home buying tours. The most noticeable drawback of using existing search mechanisms is that there is no single searchable database application that allows a user to search for developments that offer home buying tours. Secondly, the prior application also lacks the capability of allowing the purchasers to choose a hotel of their choice to stay in when they travel to the city where the tour takes place.

### SUMMARY OF THE INVENTION

This invention makes it possible for users to register for home buying tours from a mobile phone by searching for a property, seeing color-coded results on a map, clicking to view property details, and finally completing a form to register for the tour. By storing tour-related information in the database along with general property information, The Mobile Platform for Home Buying Tours is able to show a video to potential buyers and invite them to register to take a tour at the property. While the system is intended for popular browsers on mobile devices, such as cell phones, the web application is designed to work on any major browser on any device, including laptops, PCs, and tablets.

### Definitions

Users: Users are people that interact with the web application from a web browser on any internet-connected device.

Web Server: The web server is an application/service that runs on computer servers that listen for HTTP/S requests. When a valid request is received by the web server, the request may trigger the web application to execute. The web server is responsible for returning the output of the web application back to the user's device. This invention is independent of any web server software, but initially works with the Windows standard web server; Internet Information Services (IIS).

Web Application: The web application is the computer program that processes HTTP/S requests from the web server. For example, when a user is browsing the website, and they click a link to view the details of a property, the web application will collect the most up-to-date sets of information from the database and return a formatted HTML file to the user.

Database: The database is the place where information about properties, users, tours, registrations is stored. The web application reads from and writes to the database in order to process requests from the user. This invention is independent of the type of database software used by the web application. The initial implementation of the invention uses a common relational database: SQL Server.

Maps: The mapping software used by this invention can be any mapping program readily available for developers, including Google Maps, MapQuest, etc. The web application simply uses the map's API to convey to the map software where to focus, how close to zoom, and where the pins should be. The program may also format the tooltip on each of the pins of the map to provide additional information about the property/tour for which that pin represents.

### Search Results:

On Map: When a user searches for properties, matching properties from the database are shown as pins on a map. The user can click on the pin to view the tooltip and/or browse to another page that contains the full property details.
On List: Matching properties may also be shown in a list format, where the user can see an abbreviated version of the property details. The user can click on the property name or any other link within the abbreviated details to browse to another page that contains the full property details.

JSON: Commonly used format dealing with data in javascript. JSON stands for Javascript Object Notation.

Serialization: The web application, initially written with ASP.NET MVC, may at times need to send structured JSON data back to the browser in order to, for example: provide updated search results, define new map rendering information, etc. ASP.NET MVC has a built-in mechanism for serializing objects in C# to JSON. The serialization algorithm used is independent of this invention and can be any JSON serialization provided by the underlying platform. In this case, .NET does the serializing.

Routing: When a valid request is received by the web server, the details of the request, including the full URL, are relayed to the web application for processing. ASP.NET MVC has a built-in way of dealing with the request by its URL. There is a file called “RouteConfig.cs”, and this file essentially maps a URL to an ASP.NET MVC Controller. The controller then determines how to process the request. All the routing features are independent of this invention.

### DETAILED DESCRIPTION OF THE INVENTION

The invention facilitates the process of registering for home buying tours from the results of a real estate property search. The web application allows a user to enter location information on a form, and the results are displayed on a map (see FIG. 2), where graphical pins are placed on the map to indicate the exact location of the properties that matched the search criteria. The web application is available over standard HTTP/S ports 80 and 443. By simply entering a property geographical location (i.e., country, city, state, or zip code), an area map is promptly shown on the device, and once the mouse is put on a pin indicating a matching property, it will indicate if that property offers a home buying tour by using a contrasting color (see FIG. 2). Properties may also be displayed in list format (see FIG. 3). On the map, matching properties with a tour will have a different, contrasting color than properties that do not offer home buying tours. When further clicking on a specific color-coded indicator pin, the user is then taken to a “Property Details” page (see FIG. 4), where further detailed property information is presented to the user, including address, price, land area, year built, property type, building area, and a link for the user to register for the tour. Once registered, the user will be asked to provide a cell phone number where a validation code could be sent via SMS text message. The validation code will then have to be entered in the provided space to continue. After the code is validated, the user will then be redirected to a page with videos of different development projects. Each video has a link that will allow the user to make a hotel reservation in the vicinity of the actual guided tour. We display a link to a 3^{rd} party hotel reservation platform for each video/tour, allowing the user to pick their own hotel to stay in when they travel for their tour.

The relational database used in this invention contains detailed real property information, such as: property location, property type, sale price, land area, year built, building area, land use, and property tour link.

The process is repeatable. When a user changes their search criteria, any previously rendered pins would be removed before the new results are shown.

### BRIEF DESCRIPTION OF THE DRAWINGS

FIG. 1: Displays the steps a user would take as they move through the app

FIG. 2: Shows search results on a map with a form to modify the search parameters

FIG. 3: Displays search results in a list format

FIG. 4: Shows the property details screen, with indicators visible on the top for properties with Home Buying Tours

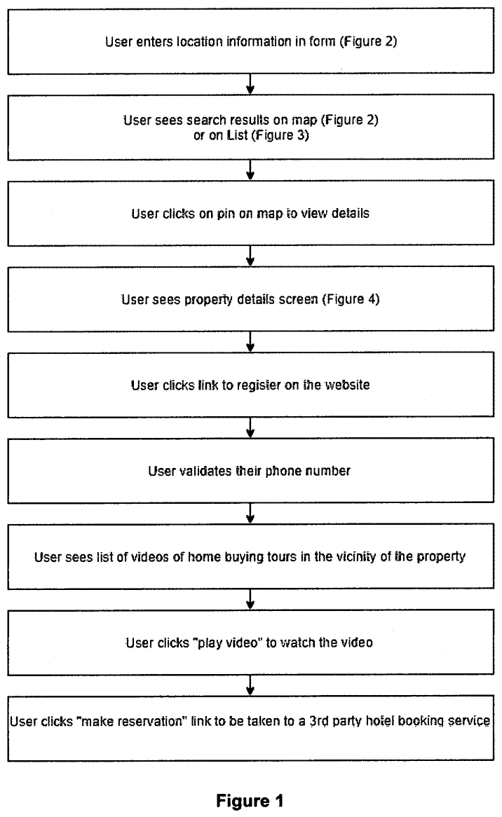

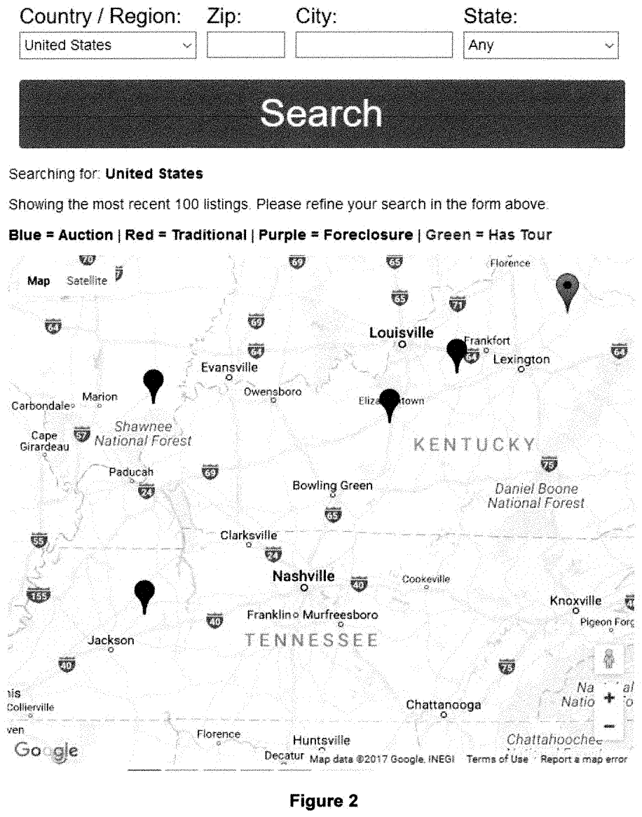

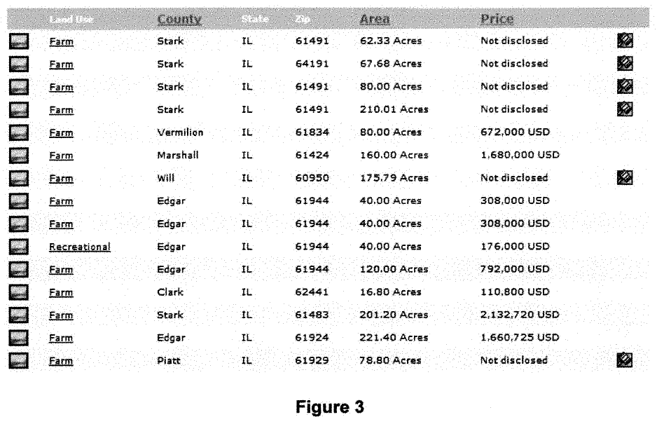

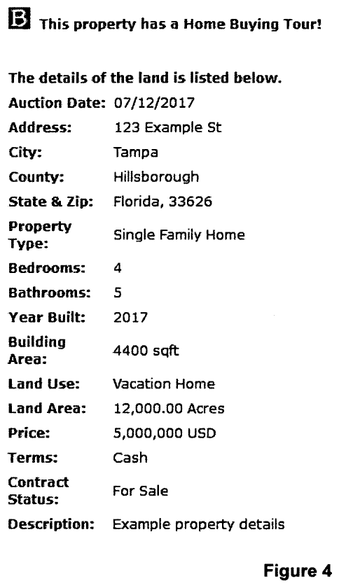

FIG. 1: The first thing the user does is enter location information. The location information is sent from the browser to the server. The application then searches the database for properties that match the search criteria. The results are returned to the browser in JSON format. The web application can then render the properties on a map (FIG. 2) and show the results in list form (FIG. 3). From the map, if the user clicks on a pin, they are taken to the property details page (FIG. 4). They can see if the property has a tour associated with it. They can then click a link to register to watch videos related to available tours on or near that property. Lastly, the user can click a link to a 3^{rd} party hotel-booking service to make a reservation to visit the area for the home buying tour.

FIG. 2: The screenshot shows the form at the top of the page with the results rendered on a map at the bottom of the page. Each pin is color-coded, and the legend is above the map. It is easy to see if a property has a tour associated with it. When you click on a pin, you are taken to the property details page.

FIG. 3: This screenshot shows the property search results in list form. Each property is linked, whereby when the user clicks the link, they are taken to the property details page. On the property detail screen, graphical icons are displayed on the right side of the list, making it easy to determine which properties have home buying tours associated with them.

FIG. 4: The property details screen shows several key pieces of information about the property including, but not limited to: city, state, zip, land use, land area. At the top of the screen, there are large pieces of texts with icons indicating if the property has a home buying tour associated with it.

I claim:

1. An integrated method for users on a web browser to search for properties that offer home buying tours.
a. A real estate database with Boolean (true or false) fields indicating whether or not the property has a home buying tour associated with it.
b. A mechanism to search stated property database by location, including city, zip, and state.
c. A formatting scheme for search results on a map, where properties with home buying tours are displayed on a map in a different color than other properties that do not have home buying tours.
d. A formatting scheme for a list of search results, with indicators for properties that have home buying tours associated with them in the database.

2. A mechanism that allows a user to register on the web application in order to watch videos about home buying tours.
a. Real estate database contains URLs for each video, and every property can have multiple videos associated with it.
b. There exists a 1-to-many relationship between properties and videos.
c. When a user is viewing the property detail page, there are indicators showing the user if there are home buying tours associated with the property.
d. A registration link is provided to the user in order for the user to progress to see videos related to home buying tours.
e. When the user registers from the property details page, they will see a list of videos associated with that property.
f. For each video displayed to the user, the user will be presented with a link to make a reservation on a 3rd party hotel booking website.
